(19) United States
(12) Patent Application Publication
(10) Pub. No.: US 2007/0040762 A1
(43) Pub. Date: Feb. 22, 2007

(54) Planar display device

(75) Inventor: Koji Shigehiro, Kumagaya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Minato-ku (JP)

(21) Appl. No.: 11/500,343

(22) Filed: Aug. 8, 2006

(30) Foreign Application Priority Data
Aug. 22, 2005 (JP) 2005-239823

(51) Int. Cl. G09G 5/00

(52) U.S. Cl. 345/1.1

(57) ABSTRACT

A planar display device includes: a first display panel having a plurality of first scan lines and a plurality of first signal lines; a second display panel having a plurality of second scan lines and a plurality of second signal lines; and a second selective connection circuit in which the plurality of second signal lines are categorized into a plurality of second signal line groups respectively representing different colors, with the plurality of second signal lines associated with the first signal lines in a first signal line group which are connected to a plurality of image signal supplying lines. In a case where a second display is performed by use of the second display panel, the second selective connection circuit connects all of the second signal lines to the corresponding first signal lines in the first signal line group.

### CROSS REFERENCE OF THE RELATED APPLICATION

This application is based upon and claims the benefit of priority from the prior Japanese Patent Application No. 2005-239823, filed on Aug. 22, 2005; the entire contents of which are incorporated herein by reference.

### BACKGROUND OF THE INVENTION

1. Field of the Invention

The present invention relates to a planar display device.

2. Discussion of the Background

Planar display devices typified by liquid crystal display devices are thin, light in weight, and low in power consumption. Because of these characteristics, the planar display devices are used as display devices for various appliances. Particularly, for appliances such as fold-type mobile phone terminal devices, the following type of planar display devices are used. In the case of this type of planar display devices, a first display panel and a second display panel are connected to each other with a flexible wiring substrate. The first display panel is a main panel for displaying an image such as a photo, a document of electronic mail, and the like. The second display panel is a sub-panel for displaying an image such as time at the present, an amount of remaining battery charge, and the like. (Refer to Japanese Patent Laid-Open Publication No. 2003-323164, for example.)

In a case of a planar display device of such a type, the first display panel includes a plurality of first scan lines, a plurality of first signal lines, and a first analog switch circuit for selectively connecting a plurality of image signal supplying lines to the first signal lines. The second display panel includes a plurality of second scan lines, a plurality of second signal lines, and a second analog switch circuit for selectively connecting the first signal lines, which are connected to the image signal supplying lines, to the second signal lines. In the first analog switch circuit, the plurality of first signal lines are categorized into three first signal line groups respectively representing R (red), G (green) and B (blue). In the second analog switch circuit, similarly, the plurality of second signal lines are categorized into three second signal line groups respectively representing R, G and B.

In a case where full-color display is performed by use of the first display panel, the first analog switch circuit repeats the following selective connection in a sequence from R, G to B. In the selective connection, the first analog switch circuit selects one first signal line group out of the three first signal line groups, and thus connects the selected first signal line group to the image signal supplying lines. In addition, in a case where full-color display is performed by use of the second display panel, the second analog switch circuit similarly repeats the following selective connection in the sequence from R, G to B. In the selective connection, the second analog switch circuit selects one second signal line group out of the three second signal line groups, and thus connects the selected second signal line group to the first signal lines group which are connected to the image signal supplying lines. On the other hand, in a case where an image such as time at the present and the amount of remaining battery charge is displayed by use of the second display panel, or in an equivalent case, monochrome display is performed by use of the second display panel.

Even in a case where the monochrome display is performed by use of the second display panel, however, the second analog switch circuit similarly repeats the foregoing selective connection in the sequence from R, G and to B as in the case where the full-color display is performed by use of the second display panel. This increases power consumption in the planar display device.

### SUMMARY OF THE INVENTION

An object of the present invention is to provide a planar display device capable of preventing increase in power consumption stemming from repetition of selective connection of signal lines in a second display panel thereof.

A characteristic of an embodiment of the present invention is that a planar display device includes a first and a second display panels for displaying an image, and a first and a second selective connection circuits. The first display panel includes a plurality of first scan lines to which a scan signal is inputted, and a plurality of first signal lines to which an image signal is inputted. The second display panel includes a plurality of second scan lines to which a scan signal is inputted, and a plurality of second signal lines to which an image signal is inputted. In the first selective connection circuit, the plurality of first signal lines are categorized into a plurality of first signal line groups respectively representing different colors, and the plurality of first lines are associated with a plurality of image signal supplying lines for supplying the image signal. In a case where display is performed by use of the first display panel, the first selective connection circuit sequentially connects the plurality of first signal lines in each of the first signal line groups to the corresponding plurality of image signal supplying lines. In a case where display is performed by use of the second display panel, the first selective connection circuit fixes the connection of the first signal lines in the first signal line group to the corresponding plurality of image signal supplying lines. In the second selective connection circuit, the plurality of second signal lines are categorized into a plurality of second signal line groups respectively representing different colors, and the plurality of second signal lines are associated with the first signal lines in the first signal line group, which are connected to the plurality of image signal supplying lines. In a case where a first display is performed as the display to be performed by use of the second display panel, the second selective connection circuit sequentially connects the plurality of second signal lines in each of the second signal line groups to the corresponding first signal lines in the first signal line group. In a case where a second display is performed as the display to be performed by use of the second display panel, the second selective connection circuit connects all of the second signal lines to the corresponding first signal lines in the first signal line group.

According to the characteristic of the embodiment of the present invention, in a case where the second display is performed by use of the second display panel, all of the second signal lines are connected to the first signal lines in the first signal line group which are connected to the plurality of image signal supplying lines with the second signal lines associated with the first signal lines. By this, in a case where, for example, monochrome display is performed as the second display, or in an equivalent case, all of the second signal lines are connected to the corresponding first signal lines in the first signal line group. Due to this state, the monochrome display is performed without repeating the selective connection of the second signal lines in the second display panel.

### BRIEF DESCRIPTION OF THE DRAWINGS

FIG. 1 is a plan view of showing a schematic configuration of a planar display device according to an embodiment of the present invention;

FIG. 2 is a circuit diagram showing the schematic configuration of the planar display device shown in FIG. 1;

FIG. 3 is a diagram for explaining an operation of full-color display performed by use of a first display panel of the planar display device shown in FIGS. 1 and 2;

FIG. 4 is a diagram for explaining an operation of full-color display performed by use of a second display panel of the planar display device shown in FIGS. 1 and 2;

FIG. 5 is a diagram for explaining an operation of monochrome display performed by use of the second display panel of the planar display device shown in FIGS. 1 and 2; and

FIG. 6 is a plan view showing a schematic configuration of a modified example of the planar display device shown in FIGS. 1 and 2.

### DETAILED DESCRIPTION OF THE INVENTION

Descriptions will be provided for an embodiment of the present invention by referring to the drawings. A planar display device 1 according to the present invention is a fold-type display device.

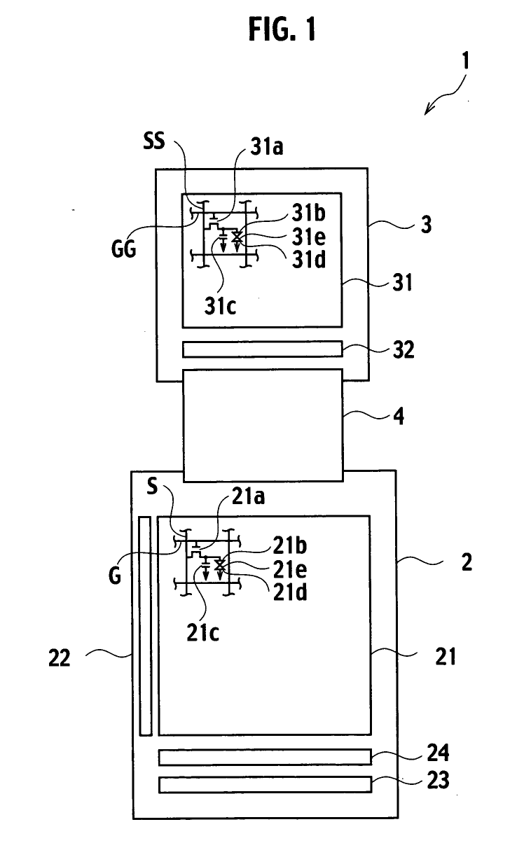

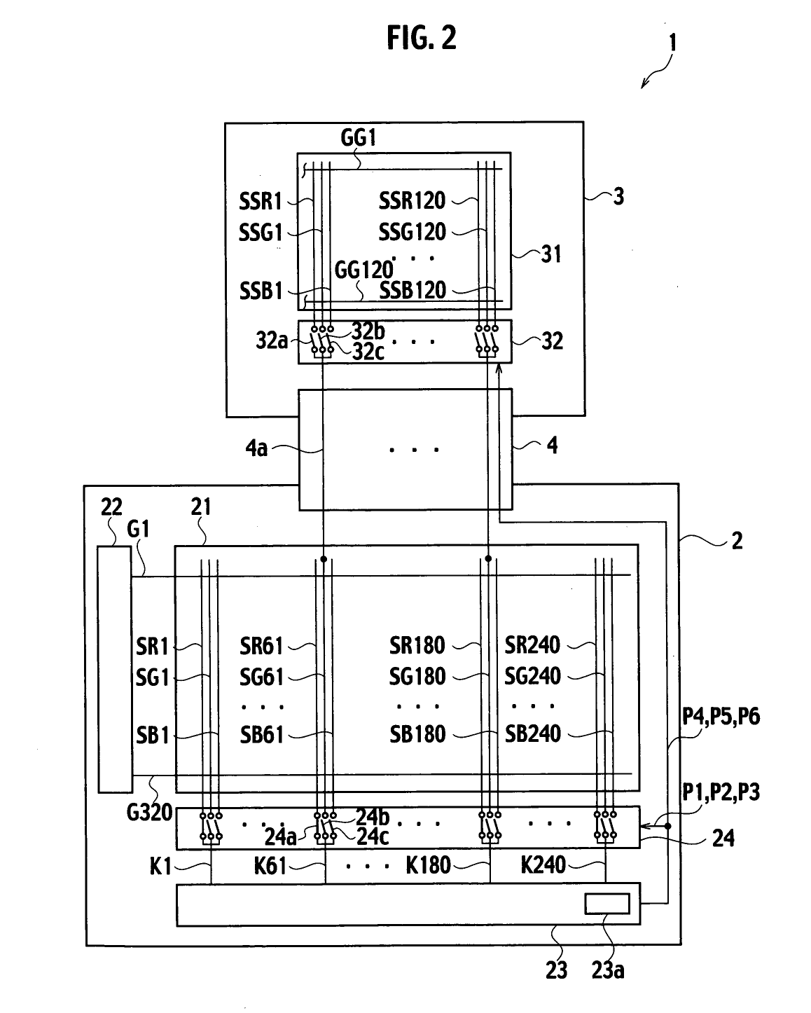

As shown in FIGS. 1 and 2, the planar display device 1 according to the present invention is configured of a first display panel 2 functioning as a main panel for displaying an image, a second display panel 3 functioning as a sub-panel for displaying an image, a flexible wiring substrate 4 for electrically connecting the first display panel 2 and the second display panel 3, and the like. The first display panel 2 is a display panel with 240×320 pixels, and the second display panel 3 is a display panel with 120×120 pixels.

The first display panel 2 includes a first display section 21, a scan line driving circuit 22, a signal line driving circuit 23 and a first selective connection circuit 24. The first display section 21 includes a plurality of first scan lines G (G1 to G320) and a plurality of first signal lines S (SR1, SG1, SB1, . . . , SR240, SG240 and SB240). Scan signals are inputted to the plurality of first scan lines G, and image signals are inputted to the plurality of first signal lines S. The scan line driving circuit 22 drives the first scan lines G. The signal line driving circuit 23 drives the first signal lines S. The first selective connection circuit 24 selectively connects the first signal lines S to the signal line driving circuit 23.

The second display panel 3 includes a second display section 31 and a second selective connection circuit 32. The second display section 31 includes a plurality of second scan lines GG (GG1 to GG120) and a plurality of second signal lines SS (SSR1, SSG1, SSB1, . . . , SSR120, SSG120 and SSB120). Scan signals are inputted to the plurality of second scan lines GG, and image signals are inputted to the plurality of second signal lines SS. The second selective connection circuit 32 selectively connects the second signal lines SS to the signal line driving circuit 23 respectively via the first signal lines S. Incidentally, the scan line driving circuit 22 of the first display panel 2 drives the second scan lines GG.

The flexible wiring substrate 4 includes a plurality of connecting lines 4a for electrically connecting the first signal lines SG61 to SG180 of the first display section 21 to the second selective connection circuit 32. With this flexible wiring substrate 4, the planar display device 1 is formed to be foldable. Incidentally, a backlight system (not illustrated) is provided between the first display panel 2 and the second display panel 3 in a state where the planar display device 1 is being folded.

The first display section 21 is a transmission-type display section which uses light from the backlight system for its display. The first display section 21 is configured of the first scan lines G, the first signal lines S, a plurality of pixel electrodes 21b, a plurality of auxiliary capacitances 21c, a counter electrode 21d and a display layer 21e, and the like (refer to FIG. 1). The first scan lines G and the first signal lines S are provided in a matrix, where the first scan lines G cross over the first signal lines S. The pixel electrodes 21b and the auxiliary capacitances 21c are connected to each of the intersections between the first scan lines G and the first signal lines S through a switch element 21a. The counter electrode 21d is opposite commonly to the pixel electrodes 21b. The display layer 21e is provided between the counter electrode 21d and each of the pixel electrodes 21b. Incidentally, the counter electrode 21d is provided on a counter substrate (not illustrated). This counter substrate is provided with any one of R, G and B color layers (not illustrated) with respect to each pixel electrode 21b.

The second display section 31 is a semi-transmission-type display section which uses light from the backlight system for its display, and which further uses external light after reflecting the external light. The use of the external light for the display in this manner makes it possible to display an image without use of backlight, and to accordingly cut back on power consumption to a large extent. This second display section 31 is also configured of the second scan lines GG, the second signal lines SS, a plurality of pixel electrodes 31b, a plurality of auxiliary capacitances 31c, a counter electrode 31d and a display layer 31e, and the like (refer to FIG. 1). The second scan lines GG and the second signal lines SS are provided in a matrix, where the second scan lines GG cross over the second signal lines SS. The pixel electrodes 31b and the auxiliary capacitances 31c are connected to each of the intersections between the second scan lines GG and the second signal lines SS through a switch element 31a. The counter electrode 31d is opposite commonly to the pixel electrodes 31b. The display layer 31e is provided between the counter electrode 31d and each of the pixel electrodes 31b. Incidentally, the counter electrode 31d is provided on a counter substrate (not illustrated). This counter substrate is provided with any one of R, G and B color layers (not illustrated) with respect to each pixel electrode 31b.

For example, thin film transistors each with three terminals are used as the switch elements 21a and 31a. Each of these transistors is provided by connecting its gate electrode to corresponding one of the first scan lines G (or the second scan lines GG), by connecting its source electrode to corresponding one of the first signal lines S (or the second signal lines SS), and by connecting its drain electrode to corresponding one of the pixel electrodes 21b (the pixel electrodes 31b) and corresponding one of the auxiliary capacitances 21c (the auxiliary capacitances 31c). Transmission electrodes through which light is transmitted are used as the pixel electrodes 21b. Transmission electrodes which transmit light and reflection electrodes which reflect light are used as the pixel electrodes 31b. In addition, for example, condensers are used as the auxiliary capacitances 21c and 31c. The display layers 21e and 31e are formed as liquid crystal layers for example, by use of liquid crystal material.

The first signal lines SR1 to SR240 and the second signal lines SSR1 to SSR120 are signals lines for writing image signals to the pixel electrodes 21b and 31b corresponding to R (red). The first signal lines SG1 to SG240 and the second signal lines SSG1 to SSG120 are signal lines for writing image signals to the pixel electrodes 21b and 31b corresponding to G (green). Moreover, the first signal lines SB1 to SB240 and the second signal lines SSB1 to SSB120 are signal lines for writing image signals to the pixel electrodes 21b and 31b corresponding to B (blue).

In a case where display is performed by the first display panel 2, the scan line driving circuit 22 sequentially outputs first scan signals to the first scan lines G during each horizontal scan period (for each first scan line G), and thus drives the first scan lines G. In a case where display is performed by the second display panel 3, the scan line driving circuit 22 sequentially outputs second scan signals to the second scan lines GG during each horizontal scan period (for each second scan line GG), and thus drives the second scan lines GG. In this respect, the scan signals are signals which drive (turn on) the switch elements 21a and 31a.

In the case where display is performed by the first display panel 2, the signal line driving circuit 23 outputs image signals to the first signal lines S in synchronism with the first scan signals, and thus drives the first signal lines S. In the case where display is performed by the second display panel 3, the signal line driving circuit 23 outputs image signals to the second signal lines SS in synchronism with the second scan signals, and thus drives the second signal lines SS. In this respect, the image signals are signals which apply voltage to the pixel electrodes 21b and 31b on the basis of image data.

Furthermore, the signal line driving circuit 23 outputs signal line selecting signals P1, P2 and P3, as control signals, to the first selective connection circuit 24. The signal line driving circuit 23 outputs signal line selecting signals P4, P5, and P6, as control signals, to the second selective connection circuit 32. This signal line driving circuit 23 functions as a control circuit for controlling the drive of the first selective connection circuit 24 and the second selective connection circuit 32.

Moreover, the signal line driving circuit 23 includes a storage unit 23a in which display data are stored. For example, SRAM (Static Random Access Memory) is used as the storage unit 23a. In addition, image signal supplying lines K (K1 to K240) through which the image signals are supplied on the basis of the display data are connected to the signal line driving circuit 23.

The first selective connection circuit 24 is a circuit which selectively connects the first signal lines S respectively to the image signal supplying lines K1 to K240 on the basis of the signal line selecting signals P1, P2 and P3, while causing the first signal lines S to correspond respectively to the image signal supplying lines K1 to K240. This first selective connection circuit 24 categorizes the first signal lines S into three first signal line groups according to the three colors R, G and B. On the basis of the signal line selecting signals P1, P2 and P3, the first selective connection circuit 24 selects one first signal line group out of the three first signal line groups, and thus connects the selected first signal line group to the image signal supplying lines K1 to K240. The first selective connection circuit 24 repeats the foregoing operation in a sequence from R, G to B.

Note that the first signal lines SR1 to SR240 constitute the first signal line group of R, the first signal lines SG1 to SG240 constitute the first signal line group of G, and the first signal lines SB1 to SB240 constitute the first signal line group of B.

More specifically, the first selective connection circuit 24 includes a plurality of analog switches 24a, a plurality of analog switches 24b and a plurality of analog switches 24c (refer to FIG. 2). The analog switches 24a are switches corresponding to the first signal line group of R, and turn on and off in response to the signal line selecting signals P1. The analog switches 24b are switches corresponding to the first signal line group of G, and turn on and off in response to the signal line selecting signals P2. The analog switches 24c are switches corresponding to the first signal line group of B, and turn on and off in response to the signal line selecting signals P3.

For example, thin film transistors are used as the analog switches 24a, 24b and 24c. The signal line selecting signals P1, P2 and P3 are inputted to gate electrodes of the analog switches 24a, 24b and 24c, respectively.

In a case where the signal line selecting signal P1 rises to a high level (High potential), the analog switches 24a turn on, and thus the first signal lines SR1 to SR240 constituting the first signal line group of R are connected to the image signal supplying lines K1 to K240, respectively. In a case where the signal line selecting signal P2 rises to a high level, the analog switches 24b turn on, and thus the first signal lines SG1 to SG240 constituting the first signal line group of G are connected to the image signal supplying lines K1 to K240, respectively. In a case where the signal line selecting signal P3 rises to a high level, the analog switches 24c turn on, and thus the first signal lines SB1 to SB240 constituting the first signal line group of B are connected to the image signal supplying lines K1 to K240. In this manner, the image signals are supplied to the first signal lines S which have been connected to the image signal supplying lines K, respectively.

The second selective connection circuit 32 is a circuit which selectively connects the second signal lines SS respectively to the image signal supplying lines K61 to K180 on the basis of the signal line selecting signals P4, P5 and P6, while causing the second signal lines SS to correspond respectively to the first signal lines S connected to the image signal supplying lines K61 to K180. This second selective connection circuit 32 categorizes the second signal lines SS into three second signal line groups according to the three colors R, G and B. On the basis of the signal line selecting signals P4, P5 and P6, the second selective connection circuit 32 selects one second signal line group out of the three second signal line groups, and thus connects the selected second signal line group to the first signal lines SG61 to SG180 connected respectively to the image signal supplying lines K61 to K180. The second selective connection circuit 32 repeats the foregoing operation in a sequence from R, G to B.

Note that the second signal lines SSR1 to SSR120 constitute the second signal line group of R, the second signal lines SSG1 to SSG120 constitute the second signal line group of G, and the second signal lines SSB1 to SSB120 constitute the second signal line group of B.

More specifically, the second selective connection circuit 32 includes a plurality of analog switches 32a, a plurality of analog switches 32b and a plurality of analog switches 32c (refer to FIG. 2). The analog switches 32a are switches corresponding to the second signal line group of R, and turn on and off in response to the signal line selecting signals P4. The analog switches 32b are switches corresponding to the second signal line group of G, and turn on and off in response to the signal line selecting signals P5. The analog switches 24c are switches corresponding to the second signal line group of B, and turn on and off in response to the signal line selecting signals P6.

For example, thin film transistors are used as the analog switches 32a, 32b and 32c. The signal line selecting signals P4, P5 and P6 are inputted to gate electrodes of the analog switches 32a, 32b and 32c, respectively.

In a case where the signal line selecting signal P4 rises to a high level (High potential), the analog switches 32a turn on, and thus the second signal lines SSR1 to SSR120 constituting the second signal line group of R are respectively connected to the image signal supplying lines K61 to K120 through the first signal lines SR61 to SR180. In a case where the signal line selecting signal P5 rises to a high level, the analog switches 32b turn on, and thus the second signal lines SSG1 to SSG120 constituting the second signal line group of G are respectively connected to the image signal supplying lines K61 to K180 through the first signal lines SG61 to SG180. In a case where the signal line selecting signal P6 rises to a high level, the analog switches 32c turn on, and thus the second signal lines SSB1 to SSB120 constituting the second signal line group of B are respectively connected to the image signal supplying lines K61 to K180 through the first signal lines SB61 to SB180. In this manner, the image signals are supplied to the second signal line SS which have been connected to the image signal supplying lines K through the first signal lines S, respectively.

Descriptions will be provided next for display operations of the planar display device 1 configured in the foregoing manner. The planar display device 1 performs full-color display by use of the first display panel 2, full-color display (first display) by use of the second display panel 3, and monochrome display (second display) by use of the second display panel 3.

In a case where the full-color display is performed by use of the first display panel 2, the signal line driving circuit 23 controls levels respectively of the signal line selecting signals P1, P2 and P3. Thus, the signal line driving circuit 23 causes the first selective connection circuit 24 to sequentially perform the following selective connection in a sequence from R, G to B. In this selective connection, the first selective connection circuit 24 selects one first signal line group out of the three first signal line groups, and connects the selected first signal line group to the image signal supplying lines K1 to K240. Moreover, the signal line driving circuit 23 controls levels respectively of the signal line selecting signals P4, P5 and P6. Thus, the signal line driving circuit 23 causes the second selective connection circuit 32 to disconnect the connection of the first signal lines SG61 to SG180 to the second signal lines SS (SSR1, SSG1, SSB1, . . . , SSR120, SSG120 and SSB120).

In response to that, the first selective connection circuit 24 repeats the selective connection in the sequence from R, G to B. In the selective connection, the first selective connection circuit 24 selects one first signal line group out of the three first signal line groups, and connects the selected first signal line group to the image signal supplying lines K1 to K240. The second selective connection circuit 32 disconnects the connection of the first signal lines SG61 to SG180 to the second signal lines SS, and fixes the disconnection.

More specifically, the signal line driving circuit 23 sequentially sets the signal line selecting signals P1, P2 and P3 at a high level/low level in this sequence with the signal line selecting signals P1, P2 and P3 synchronized with the first scan signal during one horizontal scan period. In addition, the signal line driving circuit 23 fixes all of the signal line selecting signals P4, P5 and P6 at the low level.

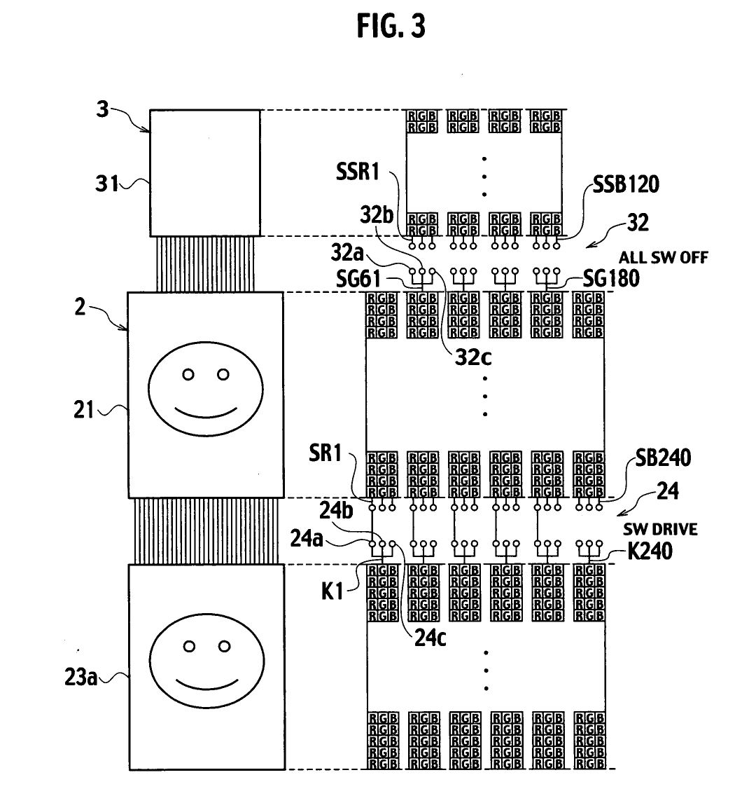

In response to that, as shown in FIG. 3, the analog switches 24a, 24b and 24c in the first selective connection circuit 24 sequentially perform an on/off drive (SW DRIVE) in this sequence. The analog switches 32a, 32b and 32c in the second selective connection circuit 32 are all turned off (ALL SW OFF). Incidentally, a color image as shown in FIG. 3, such as a photo, is stored, as image data, in the storage unit 23a.

During one horizontal scan period, write is performed three times in the first display section 21 in the first display panel 2, in conjunction with the analog switches 24a, 24b and 24c in the first selective connection circuit 24 sequentially performing the on/off drive during the horizontal scan period. The write corresponds to one of R, G and B in this sequence each time the write is performed. Thereby, image signals corresponding to R, G and B are written in each of the pixel electrodes 21b for each first scan line G. As a result, the color image as shown in FIG. 3, such as a photo, is displayed. Furthermore, in the second display section 31 in the second display panel 3, the connection of the first signal lines SG61 to SG180 to the second signal lines SS is disconnected and fixed in conjunction with the analog switches 32a, 32b and 32c in the second selective connection circuit 32 being all turned off.

Subsequently, in a case where the full-color display is performed by use of the second display panel 3, the signal line driving circuit 23 controls levels respectively of the signal line selecting signals P1, P2 and P3. Thus, the signal line driving circuit 23 causes the first selective connection circuit 24 to fix the connection of the image signal supplying lines K61 to K180 to the first signal lines SG61 to SG180. Furthermore, the signal line driving circuit 23 causes the second selective connection circuit 32 to sequentially perform the following selective connection in a sequence from R, G to B. In this selective connection, the second selective connection circuit 32 selects one second signal line group out of the three second signal line groups, and connects the selected second signal line group to the first signal lines SG61 to SG180 connected respectively to the image signal supplying lines K61 to K180.

In response to that, the first selective connection circuit 24 fixes the connection of the image signal supplying lines K61 to K180 to the first signal lines SG61 to SG180. The second selective connection circuit 32 repeats the selective connection in the sequence from R, G to B. In the selective connection, the first selective connection circuit 32 selects one second signal line group out of the three second signal line groups, and connects the selected second signal line group to the first signal lines SG61 to SG180 respectively connected to the image signal supplying lines K61 to K180.

More specifically, the signal line driving circuit 23 fixes the signal line selecting signals P1 and P3 at the low level, and fixes the signal line selecting signal P2 at the high level. Thus, the signal line driving circuit 23 sequentially sets the signal line selecting signals P4, P5 and P6 at the high level/low level in this sequence with the signal line selecting signals P4, P5 and P6 synchronized with the second scan signal during one horizontal scan period.

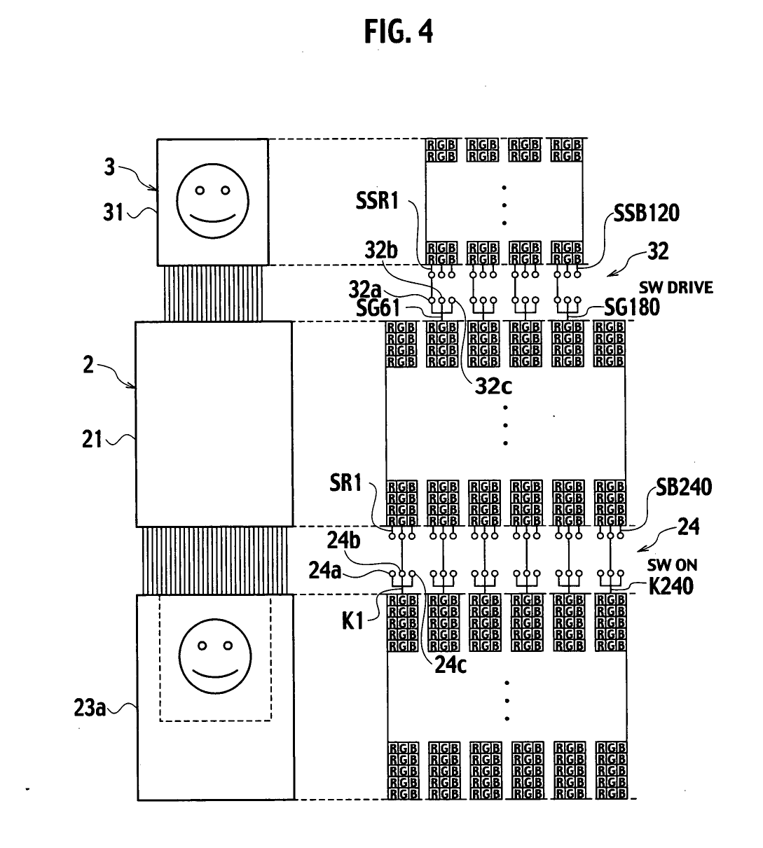

In response to that, as shown in FIG. 4, the analog switches 24a and 24c in the first selective connection circuits 24 are turned off, and the analog switches 24b therein are turned on (SW ON). The analog switches 32a, 32b and 32c in the second selective connection circuit 32 are sequentially driven on/off in this sequence (SW DRIVE). Incidentally, a color image as shown in FIG. 4, such as a photo, is stored in, as image data, the storage unit 23a.

In the first display section 21 of the first display panel 2, the connection of the image signal supplying lines K61 to K180 respectively to the first signal lines SG61 to SG180 is fixed in conjunction with the analog switches 24b in the first selective connection circuit 24 being turned on. Furthermore, during one horizontal scan period, write is performed three times in the second display section 31 in the second display panel 3, in conjunction with the analog switches 32a, 32b and 32c in the second selective connection circuit 32 sequentially performing the on/off drive during the horizontal scan period. The write corresponds to one of R, G and B in this sequence each time the write is performed. Thereby, image signals corresponding to R, G and B are written in each of the pixel electrodes 31b for each second scan line GG. As a result, the color image as shown in FIG. 4, such as a photo, is displayed.

On the other hand, in a case where the monochrome display is performed by use of the second display panel 3, the signal line driving circuit 23 controls levels respectively of the signal line selecting signals P1, P2 and P3. Thus, the signal line driving circuit 23 causes the first selective connection circuit 24 to fix the connection of the image signal supplying lines K61 to K180 respectively to the first signal lines SG61 to SG180. In addition, the signal line driving circuit 23 controls levels respectively of the signal line selecting signals P4, P5 and P6. Thus, the signal line driving circuit 23 causes the second selective connection circuit 32 connect all of the first signal lines SG61 to SG180 connected to the image signal supplying lines K61 to K180 respectively to all of the second signal lines SS.

In response to that, the first selective connection circuit 24 fixes the connection of the image signal supplying lines K61 to K180 to the first signal lines SG61 to SG180. The second selective connection circuit 32 causes the first signals lines SG61 to SG180 connected to the image signal supplying lines K61 to K180 to correspond to all the second signal lines SS, and thus connects the first signals lines SG61 to SG180 to the second signal lines SS, hence fixing the connection.

More specifically, the signal line driving circuit 23 fixes the signal line selecting signals P1 and P3 at the low level, and fixes the signal line selecting signal P2 at the high level. In addition, the signal line driving circuit 23 fixes the signal line selecting signals P4, P5 and P6 at the high level.

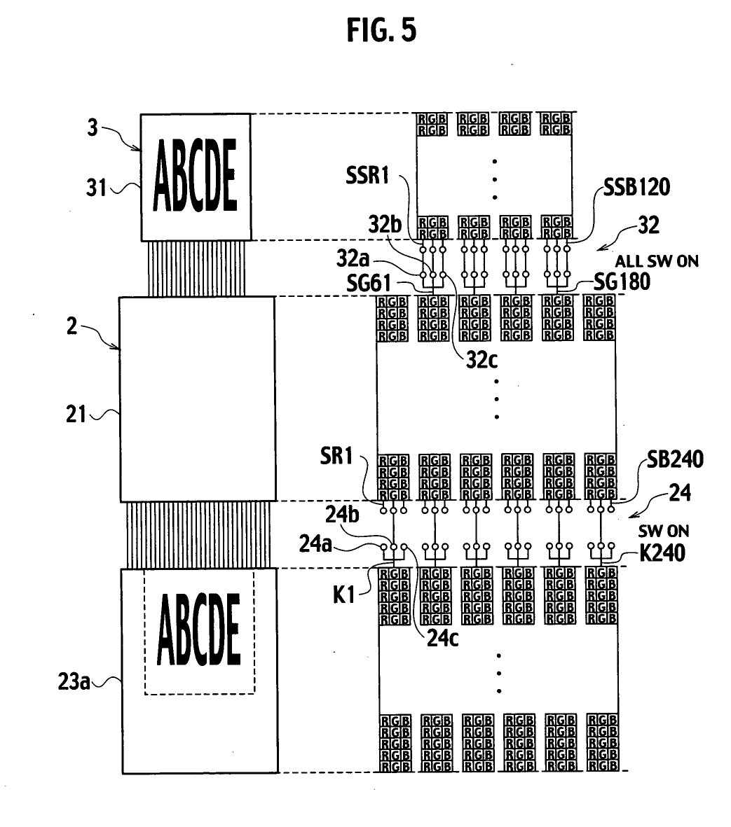

In response to that, as shown in FIG. 5, the analog switches 24a and 24c in the first selective connection circuit 24 are turned off, and the analog switches 24b therein are turned on (SW ON). The analog switches 32a, 32b and 32c in the second selective connection circuit 32 are all turned on (ALL SW ON). Incidentally, a monochrome image as shown in FIG. 5, such as characters (for example, time at the present) is stored, as image data, in the storage unit 23a.

In the first display section 21 of the first display panel 2, the connection of the image signal supplying lines K61 to K180 to the first signal lines SG61 to SG180 is fixed in conjunction with the analog switches 24b in the first selective connection circuit 24 being turned on. In addition, in the second display section 31 of the second display panel 3, write is performed once in every horizontal scan period in the state where the analog switches 32a, 32b and 32c in the second selective connection circuit 32 are all turned on. Thereby, the image signals are written thereto in each of the pixel electrodes 31b for each second scan line GG. As a result, the monochrome image as shown in FIG. 5, such as characters, is displayed. In other words, the write at the same potential is performed on the R, G and B pixel electrodes 31b constituting a pixel in the second display panel 3.

With regard to the embodiment of the present invention, as described above, in the case where the monochrome display is performed by use of the second display panel 3, all of the second signal lines SS are connected to the first signal lines SG61 to SG180 connected to the image signal supplying lines K61 to K180 with the second signal lines SS associated with the first signal lines SG61 to SG180. This creates the state where all of the second signal lines SS are connected to the corresponding first signal lines SG61 to SG180. The write at the same potential is performed on the R, G and B pixel electrodes 31b constituting a pixel in the second display 3. Thus, the monochrome display is performed. In the case where the monochrome display is performed by use of the second display panel 3 as described above, the selective connection of the second signal lines SS is not repeated unlike the case where the full-color display is performed by use of the second display panel 3. This makes it possible to prevent increase in power consumption stemming from the repetition of the selective connection of the second signal lines SS.

In addition, in the second selective connection circuit 32, the second signal lines SS are categorized into the three second signal line groups respectively representing different colors. In the case where the full-color display is performed by use of the second display panel 3, the second signal lines SS are sequentially connected to the corresponding first signal lines SG61 to SG180 for each second signal line group. This makes it possible to perform a high-quality color display by use of the second display panel 3.

Furthermore, the first selective connection circuit 24 is provided to the first display panel 2, and the second selective connection circuit 32 is provided to the second display panel 3. This makes it unnecessary to provide another substrate or the like for the purpose of placing the first selective connection circuit 24 and the second selective connection circuit 32. This makes it possible to construct the planer display device 1 in smaller size, to additionally reduce the number of parts and the number of steps of mounting the parts, and to accordingly offer the planar display device 1 at a lower price.

It should be noted that the present invention is not limited to the foregoing embodiment, and that various modifications can be made to the present invention within a scope not departing from the essence and sprit of the present invention.

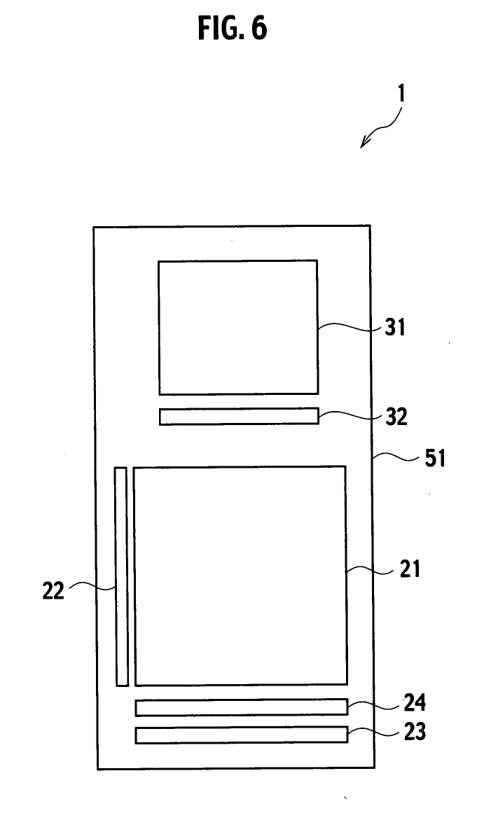

For example, in the case of the foregoing embodiment, the first display panel 2 and the second display panel 3 are provided as the separate panels. However, neither the first display panel 2 nor the second display panel 3 is limited to this example. For example, as shown in FIG. 6, the first display panel 2 and the second display panel 3 may be provided as an integrated display panel 51. The integrated display panel 51 makes it unnecessary to provide the flexible wiring substrate 4 for electrically connecting the first display panel 2 and the second display panel 3. This makes it possible to reduce the number of parts and the number of steps of mounting the parts, and to accordingly offer the planar display device 1 at a lower price.

Moreover, in the case of the foregoing embodiment, the first signal lines S are categorized into the three first signal line groups, and the second signal lines SS are categorized into the three second signal line groups. However, neither the first signal lines S nor the second signal lines SS are limited to this example. For example, the first signal lines S may be categorized into four first signal line groups, and the second signal lines SS may be categorized into four second signal line groups.

In the case of the foregoing embodiment, the display layers 21e and 31e are formed as the liquid crystal layers by use of liquid crystal material. However, neither the display layers 21e nor the display layers 31e are limited to this example. For example, the display layers 21e and 31e may be formed by use of light emitting material, and accordingly the planar display device 1 may be constructed as an organic EL (electroluminescence) display device.

What is claimed is:

1. A planar display device comprising:
a first display panel for displaying an image, the first display panel including a plurality of first scan lines to which a scan signal is inputted and a plurality of first signal lines to which an image signal is inputted;
a second display panel for displaying an image, the second display panel including a plurality of second scan lines to which a scan signal is inputted and a plurality of second signal lines to which an image signal is inputted;
a first selective connection circuit in which the plurality of first signal lines are categorized into a plurality of first signal line groups respectively representing different colors, with the plurality of first signal lines associated with a plurality of image signal supplying lines for supplying the image signal, the first selective connection circuit sequentially connecting the plurality of first signal lines in each of the first signal line groups to the corresponding plurality of image signal supplying lines in a case where display is performed by use of the first display panel, and the first selective connection circuit fixing the connection of the first signal lines in the first signal line group to the corresponding plurality of image signal supplying lines in a case where display is performed by use of the second display panel; and
a second selective connection circuit in which the plurality of second signal lines are categorized into a plurality of second signal line groups respectively representing different colors, with the plurality of second signal lines associated with the first signal lines in the first signal line group which are connected to the plurality of image signal supplying lines, the second selective connection circuit sequentially connecting the plurality of second signal lines in each of the second signal line groups to the corresponding first signal lines in the first signal line group in a case where a first display is performed as the display to be performed by use of the second display panel, and the second selective connection circuit connecting all of the second signal lines to the corresponding first signal lines in the first signal line group in a case where a second display is performed as the display to be performed by use of the second display panel.

2. The planar display device according to claim 1, wherein the first display panel includes the first selective connection circuit, and
the second display panel includes the second selective connection circuit.

3. The planar display device according to claim 1, wherein the first display panel and the second display panel are integrated.
